(19) United States
(12) Patent Application Publication
(10) Pub. No.: US 2002/0115321 A1
(43) Pub. Date: Aug. 22, 2002

(54) Rotary electric contactor

(76) Inventor: Jean-Christophe Mange, Saint Maurice (FR)

Correspondence Address: Oliff & Berridge, PO Box 19928, Alexandria, VA, 22320, US

(21) Appl. No.: 10/019,648

(22) PCT Filed: May 2, 2001
(86) PCT No.: PCT/FR01/01340

(30) Foreign Application Priority Data
May 3, 2000 (FR) 00/05622

(51) Int. Cl. H01R 3/00

(52) U.S. Cl. 439/164

(57) ABSTRACT

The invention relates to a conductor-ribbon held via one of its edge faces against one plate coated in an insulating material on its face facing towards said conductor-ribbon. The insulating material is a foam and the edge face of the conductor-ribbon is rounded and bears directly against the foam.

The present invention relates to a rotary electric contactor including a conductor-ribbon.

Rotary contactors are devices that enable parts that pivot relative to one another to be electrically interconnected.

They are used in particular on the steering columns of motor vehicles for connecting electrical equipment mounted on the steering wheel to apparatus fixed to the vehicle.

In that type of device, the conductor-ribbon is enclosed in a housing which is defined in particular by two parallel plates between which the top and bottom edge faces of the conductor-ribbon come to bear.

One of the ends of the conductor-ribbon is fixed to a stator which is generally located at the periphery of the contactor. The other end of the conductor-ribbon is connected to a rotor, usually housed inside the stator.

In known rotary contactors, it has already been found that the conductor-ribbon suffers from vibration and/or rubbing against the parallel plates between which it is held, thus giving rise to undesirable noise.

Various solutions have been proposed in an attempt to resolve that problem. One such solution consists in coating the faces of the parallel plates looking towards the conductor-ribbon with multilayer composites comprising a foam and a slippery film serving both to damp vibration of the ribbon and to avoid friction between its edge faces and the plates.

Nevertheless, that solution is relatively expensive and does not give entire satisfaction, particularly concerning vibration.

Another known solution consists in replacing the composites by sheets of baize, which serve in particular to improve vibration damping, but that solution suffers from the drawback whereby the baize becomes nappy in the long run.

The present invention seeks to provide a solution to those problems that is effective and of low cost.

To this end, the present invention provides a rotary electric contactor having a conductor-ribbon held via one of its edge faces against one plate coated in an insulating material on its face facing towards said conductor-ribbon, the contactor being characterized in that the insulating material is a foam and in that the edge face of the conductor-ribbon is rounded and bears directly against the foam.

By means of the invention, it is no longer necessary for the plate(s) of the contactor to be provided with foam/film composite material which considerably increases the cost price of a conventional rotary electric contactor, nor is it necessary to provide a sheet of baize which is liable to become worn.

Because of the rounded shape of its edge faces, the conductor-ribbon can be put directly into contact with a foam coating covering the plates of the contactor.

In addition, by eliminating the slippery film covering the foam in prior art contactors, the effectiveness of the foam as a vibration damper is improved.

In a particular embodiment of the invention, the foam is in the form of a non-adhesive sheet interposed between the conductor-ribbon and the plate. Its low weight means that it can be left free between the edge face of the conductor and the face of the plate that faces towards the conductor.

If necessary, the sheet of foam can also be stuck to the plate.

Various techniques can be used to make the rounded edge face of the conductor-ribbon.

One of them consists in enclosing conductive strips in a sheet of plastics material that is folded over so as to form a rounded edge face at each of the edge faces of the conductor-ribbon.

Another technique which is particularly advantageous in the context of the present invention is extrusion, a technique whereby the conductive strips are coated directly in extruded plastics material.

In order to make the invention better understood, there follows a description of embodiments given as non-limiting examples and made with reference to the accompanying drawings, in which:

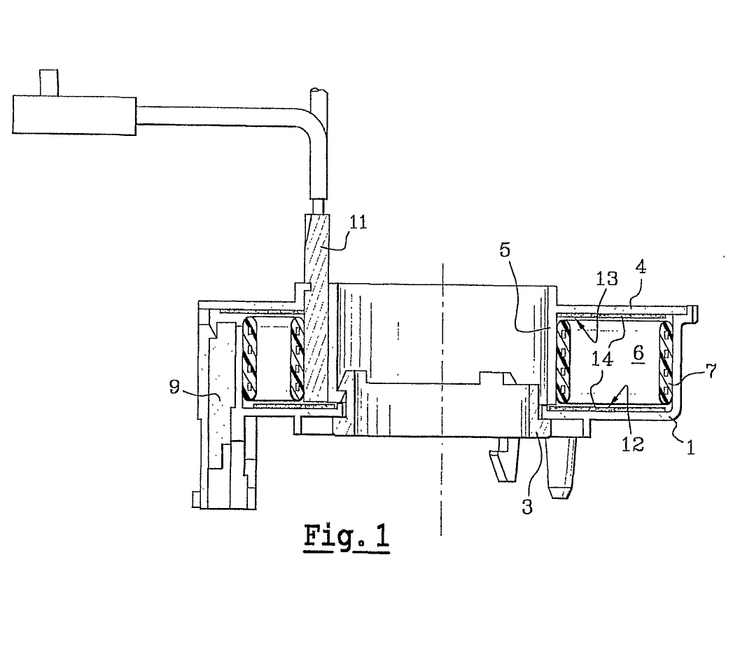

FIG. 1 is an axial section view of an electric contactor constituting an embodiment of the invention;

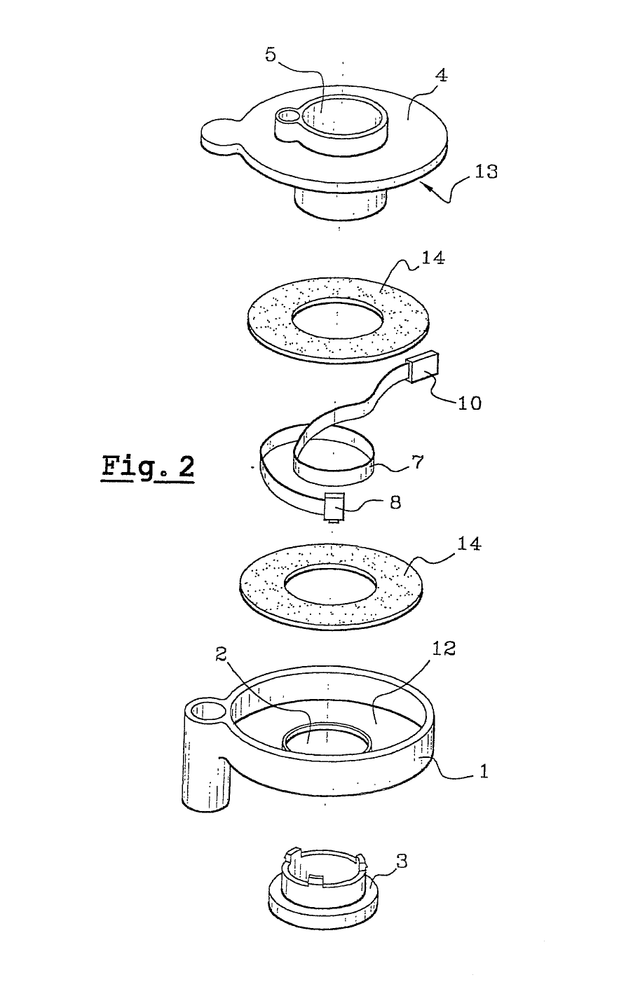

FIG. 2 is an exploded perspective view of the FIG. 1 contactor;

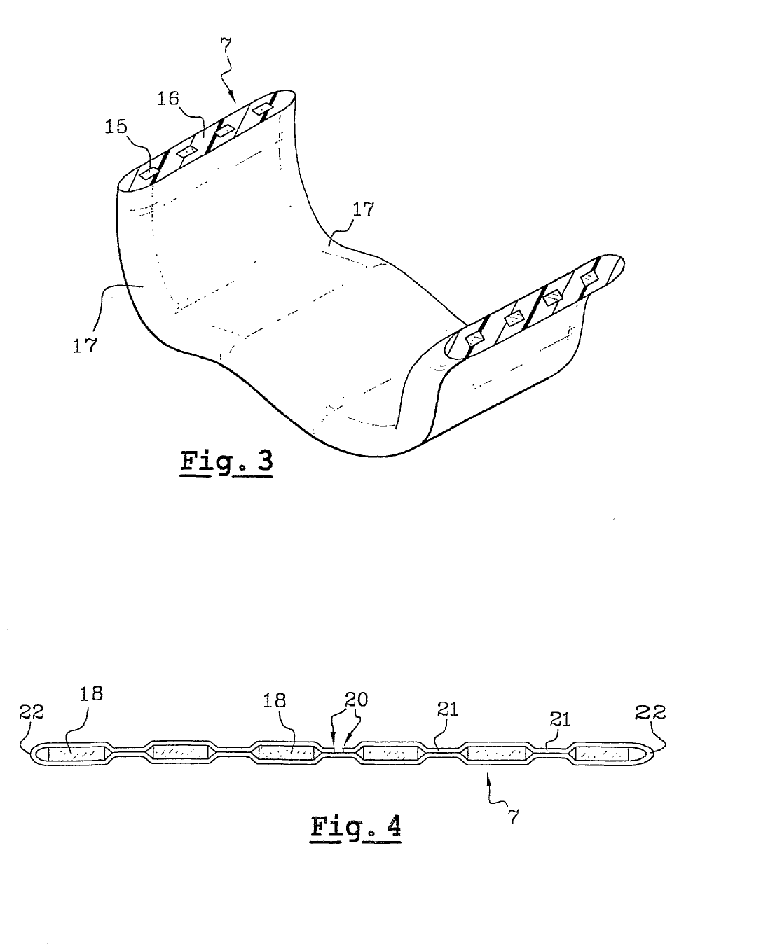

FIG. 3 is a cross-section of the conductor-ribbon on a larger scale; and

FIG. 4 is a cross-section of another conductor-ribbon.

The contactor shown in the drawings comprises, in conventional manner, a cup-shaped housing pierced centrally by an orifice 2 in which a bottom hub 3 is received.

The contactor also has a lid 4 which is formed integrally with a top hub 5 extending over the full height of the housing.

The lid 4 engages in the housing 1, and it is held therein by snap-fastening with the bottom hub 3.

This snap-fastening ensures that the lid is retained axially while leaving it free to pivot inside the housing while accompanying a rotary shaft, e.g. the shaft in a steering column supporting a steering wheel.

When the housing 1 and the lid 4 are united, they define an annular cage 6 between them suitable for containing a rolled-up conductor-ribbon 7.

The outer end 8 of the conductor-ribbon is fixed to a terminal 9 secured to the housing. The inner end 10 of the conductor-ribbon is fixed to a terminal 11 secured to the lid 4.

The bottom 12 of the housing and the inside face 13 of the lid are constituted by parallel plates between which the conductor-ribbon 7 is held inside the annular cage 6.

The bottom 12 of the housing and the inside face 13 of the lid are covered in respective sheets of foam 14 made of polyurethane, polyethylene, or polypropylene.

Each sheet of foam 14 is left free inside the cage 6. The conductor-ribbon 7 holds it close to the corresponding plate 12, 13.

As can be seen more clearly in FIGS. 3 and 4, the edge faces of the conductor-ribbon, one of which faces towards the lid and the other towards the bottom of the housing, are rounded so as to avoid presenting any sharp edges.

These rounded edge faces come directly into contact with the layers of foam without the foam needing any protective coating or slippery film.

The rounded shape of each edge face suffices to prevent the foam being damaged or the conductor-ribbon becoming jammed.

FIG. 3 shows one possible embodiment of a conductor-ribbon having rounded edge faces and suitable for use in the invention.

This conductor-ribbon comprises four conductor strips 15, e.g. made of copper, and embedded in a mass 16 of extruded polyester. The edge faces 17 of the mass are rounded by an appropriate design of extruder head.

FIG. 4 shows another embodiment of the conductor-ribbon.

This conductor-ribbon has six conductive strips 18 which have been placed on a polyester sheet 19 laid out flat.

The polyester sheet is then folded over on either side of the conductive strips so as to cover them completely, with the outermost edges 20 of the sheet meeting substantially in the middle of the ribbon.

The sheet prepared in this way is subjected to hot pressing which forms bridges 21 of material between the conductive strips, thus ensuring that they are permanently positioned and insulated relative to one another.

The edge faces 22 of the ribbon as obtained in this way are rounded, i.e. they present no sharp edges.

The above embodiments are merely examples provided to enable the invention to be properly understood, however the invention is not limited in any way to the particular characteristics described with reference to these examples.

1/ A rotary electric contactor having a conductor-ribbon (7) held via one of its edge faces (17, 22) against one plate (12, 13) coated in an insulating material on its face facing towards said conductor-ribbon, the contactor being characterized in that the insulating material is a foam (14) and in that the edge face (17, 22) of the conductor-ribbon is rounded and bears directly against the foam (14).

2/ A contactor according to claim 1, characterized in that the foam is in the form of a non-adhesive sheet (14) interposed between the conductor-ribbon (7) and the plate (12, 13):

3/ A contactor according to claim 1 or claim 2, characterized in that the conductor-ribbon is obtained by extruding a mass (16) of plastics material around conductive strips (15).

4/ A contactor according to claim 1 or claim 2, characterized in that the conductor-ribbon is constituted by conductive strips (15) placed on a sheet of plastics material (19) which is folded over so as to hold the strips captive.
